(19) United States
(12) Patent Application Publication
(10) Pub. No.: US 2009/0140954 A1
(43) Pub. Date: Jun. 4, 2009

(54) METHOD OF DRIVING PLASMA DISPLAY PANEL AND PLASMA DISPLAY APPARATUS

(75) Inventors: Heekwon KIM, Gumi-city (KR); Yoonseok KWAK, Gumi-city (KR); Jongjin JEONG, Gumi-city (KR); Byunghyun KIM, Gumi-city (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/183,110

(22) Filed: Jul. 31, 2008

(30) Foreign Application Priority Data
Dec. 3, 2007 (KR) 10-2007-0124632

(51) Int. Cl. G09G 3/28

(52) U.S. Cl. 345/68

(57) ABSTRACT

A method of driving a plasma display panel displaying an image in a frame including a plurality of subfields and a plasma display apparatus are disclosed. In the method, at least one of the plurality of subfields is a selective write subfield, and at least one of the other subfields is a selective erase subfield. The plasma display panel includes a front substrate including a scan electrode and a sustain electrode, a rear substrate positioned opposite the front substrate, and a phosphor layer between the front and rear substrates. The phosphor layer includes a phosphor material and an additive material. The additive material includes at least one of magnesium oxide (MgO), zinc oxide (ZnO), silicon oxide (SiO₂), titanium oxide (TiO₂), yttrium oxide (Y₂O₃), aluminum oxide (Al₂O₃), lanthanum oxide (La₂O₃), europium oxide (EuO), cobalt oxide, iron oxide, or CNT (carbon nano tube).

This application claims the benefit of Korean Patent Application No. 10-2007-0124632 filed on Dec. 3, 2007, which is hereby incorporated by reference.

### BACKGROUND

1. Field

An exemplary embodiment relates to a method of driving a plasma display panel and a plasma display apparatus.

2. Description of the Related Art

A plasma display apparatus includes a plasma display panel.

The plasma display panel includes a phosphor layer inside discharge cells partitioned by barrier ribs and a plurality of electrodes.

When driving signals are applied to the electrodes of the plasma display panel, a discharge occurs inside the discharge cells. In other words, when the plasma display panel is discharged by applying the driving signals to the discharge cells, a discharge gas filled in the discharge cells generates vacuum ultraviolet rays, which thereby cause phosphors positioned between the barrier ribs to emit light, thus producing visible light. An image is displayed on the screen of the plasma display panel due to the visible light.

In one aspect, a method of driving a plasma display panel displaying an image in a frame including a plurality of subfields, wherein the plasma display panel includes a front substrate on which a scan electrode and a sustain electrode are positioned substantially parallel to each other, a rear substrate positioned opposite the front substrate, and a phosphor layer positioned between the front substrate and the rear substrate, the phosphor layer including a phosphor material and an additive material, the additive material including at least one of magnesium oxide (MgO), zinc oxide (ZnO), silicon oxide (SiO₂), titanium oxide (TiO₂), yttrium oxide (Y₂O₃), aluminum oxide (Al₂O₃), lanthanum oxide (La₂O₃), europium oxide (EuO), cobalt oxide, iron oxide, or CNT (carbon nano tube), wherein at least one of the plurality of subfields is a selective write subfield, and at least one of the other subfields is a selective erase subfield.

In another aspect, a method of driving a plasma display panel displaying an image in a frame including a plurality of subfields, wherein a plasma display panel includes a front substrate on which a scan electrode and a sustain electrode are positioned substantially parallel to each other, a rear substrate positioned opposite the front substrate, and a phosphor layer positioned between the front substrate and the rear substrate, the phosphor layer including a phosphor material and MgO material, wherein a first rising signal with a gradually rising voltage and a first falling signal with a gradually falling voltage are supplied to the scan electrode, and a second rising signal with a gradually rising voltage corresponding to the first rising signal is supplied to the sustain electrode during a reset period of at least one type 1 subfield of the plurality of subfields, wherein a reset period is omitted in at least one type 2 subfield of the plurality of subfields.

In still another aspect, a plasma display apparatus comprises a plasma display panel including a front substrate on which a scan electrode and a sustain electrode are positioned substantially parallel to each other, a rear substrate positioned opposite the front substrate, and a phosphor layer positioned between the front substrate and the rear substrate, the phosphor layer including a phosphor material and MgO material, and a driver that displays an image on the plasma display panel in a frame including a plurality of subfields, wherein at least one of the plurality of subfields is a selective write subfield, and at least one of the other subfields is a selective erase subfield.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention. In the drawings:

FIG. 1 shows a configuration of a plasma display apparatus according to an exemplary embodiment;

FIG. 2 shows a structure of a plasma display panel;

FIG. 3 is a diagram for explaining an example of a method of driving the plasma display panel;

FIG. 4 is a diagram for explaining an example of a method for achieving a gray scale of an image;

FIG. 5 is a diagram for explaining an example of a driving waveform during a selective write subfield and a selective erase subfield;

FIG. 6 is a diagram comparing a first rising signal with a second rising signal;

FIG. 7 is a diagram comparing a first scan signal with a second scan signal;

FIGS. 8 and 9 are diagrams for explaining a third type subfield;

FIG. 10 is a diagram for explaining a reason why a sustain period is omitted in the third type subfield;

FIG. 11 shows a phosphor layer;

FIG. 12 is a diagram for explaining an example of a method of manufacturing a phosphor layer;

FIGS. 13 and 14 are diagrams for explaining an effect of an additive material;

FIG. 15 is a diagram for explaining a content of an additive material;

FIG. 16 shows another structure of a phosphor layer;

FIG. 17 illustrates an example of another method of manufacturing a phosphor layer; and

FIG. 18 is a diagram for explaining a method of selectively using an additive material.

### DETAILED DESCRIPTION OF EMBODIMENTS

Reference will now be made in detail embodiments of the invention examples of which are illustrated in the accompanying drawings.

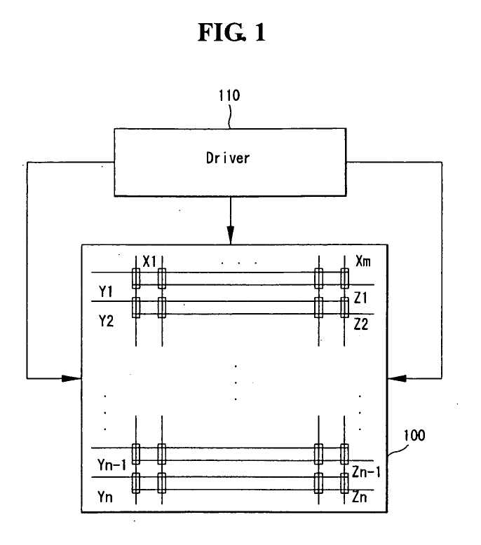

FIG. 1 shows a configuration of a plasma display apparatus according to an exemplary embodiment.

As shown in FIG. 1, the plasma display apparatus according to the exemplary embodiment includes a plasma display panel 100 and a driver 110.

The plasma display panel 100 includes scan electrodes Y1 to Yn and sustain electrodes Z1 to Zn positioned parallel to each other, and address electrodes X1 to Xm positioned to intersect the scan electrodes Y1 to Yn and the sustain electrodes Z1 to Zn.

The driver 110 includes a driving device that supplies a driving signal to at least one of the scan electrode, the sustain electrode, or the address electrode to thereby display an image on the screen of the plasma display panel 100.

Although FIG. 1 has shown the case that the driver 110 is formed in the form of a signal board, the driver 110 may be formed in the form of a plurality of boards depending on the electrodes of the plasma display panel 100. For example, the driver 110 may include a first driver (not shown) for driving the scan electrodes Y1 to Yn, a second driver (not shown) for driving the sustain electrodes Z1 to Zn, and a third driver (not shown) for driving the address electrodes X1 to Xm.

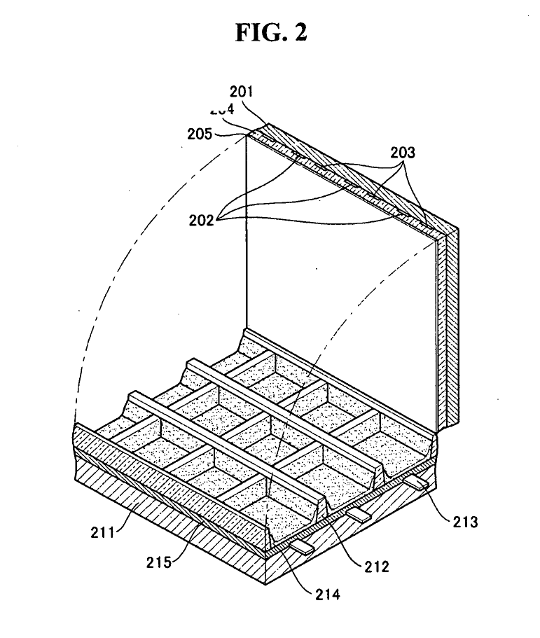

FIG. 2 shows a structure of a plasma display panel.

As shown in FIG. 2, the plasma display panel 100 may include a front substrate 201, on which a scan electrode 202 and a sustain electrode 203 are positioned parallel to each other, and a rear substrate 211 on which an address electrode 213 is positioned to intersect the scan electrode 202 and the sustain electrode 203.

An upper dielectric layer 204 may be positioned on the scan electrode 202 and the sustain electrode 203 to limit a discharge current of the scan electrode 202 and the sustain electrode 203 and to provide electrical insulation between the scan electrode 202 and the sustain electrode 203.

A protective layer 205 nay be positioned on the upper dielectric layer 204 to facilitate discharge conditions. The protective layer 205 may include a material having a high secondary electron emission coefficient, for example, magnesium oxide (MgO).

A lower dielectric layer 215 may be positioned on the address electrode 213 to cover the address electrode 213 and to provide electrical insulation of the address electrodes 213.

Barrier ribs 212 of a stripe type, a well type, a delta type, a honeycomb type, and the like, may be positioned on the lower dielectric layer 215 to partition discharge spaces (i.e., discharge cells). Hence, a first discharge cell emitting red light, a second discharge cell emitting blue light, and a third discharge cell emitting green light, and the like, may be positioned between the front substrate 201 and the rear substrate 211. In addition to the first, second, and third discharge cells, a fourth discharge cell emitting white light or yellow light may be further positioned.

Widths of the first, second, and third discharge cells may be substantially equal to one another. Further, a width of at least one of the first, second, and third discharge cells may be different from widths of the other discharge cells. For instance, a width of the first discharge cell may be the smallest, and widths of the second and third discharge cells may be larger than the width of the first discharge cell. The width of the second discharge cell may be substantially equal to or different from the width of the third discharge cell. Hence, a color temperature of an image displayed on the plasma display panel 100 can be improved.

The plasma display panel 100 may have various forms of barrier rib structures as well as a structure of the barrier rib 212 shown in FIG. 2. For instance, the barrier rib 212 includes a first barrier rib and a second barrier rib crossing each other. The barrier rib 212 may have a differential type barrier rib structure in which heights of the first and second barrier ribs are different from each other, a channel type barrier rib structure in which a channel usable as an exhaust path is formed on at least one of the first barrier rib or the second barrier rib, a hollow type barrier rib structure in which a hollow is formed on at least one of the first barrier rib or the second barrier rib, and the like.

While FIG. 2 has shown and described the case where the first, second, and third discharge cells are arranged on the same line, the first, second, and third discharge cells may be arranged in a different pattern. For instance, a delta type arrangement in which the first, second, and third discharge cells are arranged in a triangle shape may be applicable. Further, the discharge cells may have a variety of polygonal shapes such as pentagonal and hexagonal shapes as well as a rectangular shape.

Each of the discharge cells partitioned by the barrier ribs 212 may be filled with a discharge gas.

A phosphor layer 214 may be positioned inside the discharge cells to et visible light for an image display during an address discharge. For instance, first, second, and third phosphor layers that produce red, blue, and green light, respectively, may be positioned inside the discharge cells. In addition to the first, second, and third phosphor layers, a fourth phosphor layer producing white and/or yellow light may be further positioned.

A thickness of at least one of the first, second, and third phosphor layers may be different from thicknesses of the other phosphor layers. For instance, a thickness of the second phosphor layer or the third phosphor layer may be larger than a thickness of the first phosphor layer. The thickness of the second phosphor layer may be substantially equal or different from the thickness of the third phosphor layer.

In FIG. 2, the upper dielectric layer 204 and the lower dielectric layer 215 each have a single-layered structure. However, at least one of the upper dielectric layer 204 or the lower dielectric layer 215 may have a multi-layered structure.

A black layer (not shown) capable of absorbing external light may be further positioned on the barrier rib 212 so as to prevent the external light from being reflected by the barrier rib 212. Further, another black layer (not shown) may be further positioned at a predetermined location of the front substrate 201 to correspond to the barrier rib 212.

While the address electrode 213 may have a substantially constant width or thickness, a width or thickness of the address electrode 213 inside the discharge cell may be different from a width or thickness of the address electrode 213 outside the discharge cell. For instance, a width or thickness of the address electrode 213 inside the discharge cell may be larger than a width or thickness of the address electrode 213 outside the discharge cell.

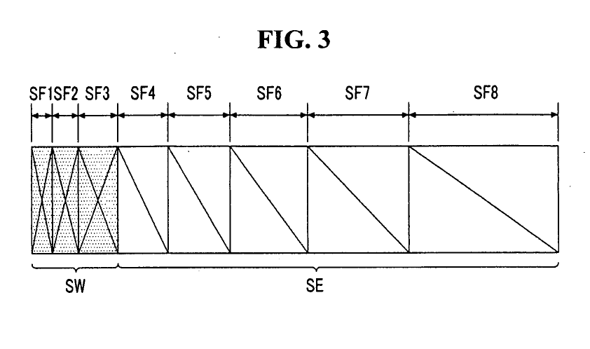

FIG. 3 is a diagram for explaining an example of a method of driving the plasma display panel.

As shown in FIG. 3, at least one of a plurality of subfields constituting a frame is a selective write subfield, and at least one of the other subfields is a selective erase subfield.

Supposing that a frame includes a total of 8 subfields SF1 to SF8, the first to third subfields SF1 to SF3 are called a first part, and the fourth to eighth subfields SF4 to SF8 are called a second part. The first part may include at least one selective write subfield, and the second part may include at least one selective erase subfield.

It may be advantageous that all the selective erase subfields follow at least one selective write subfield. For instance, if the third subfield SF3 is a selective write subfield, the fourth to eighth subfields SF4 to SF8 may be a selective erase subfield.

The discharge cell to which a scan signal is supplied during an address period of a selective write subfield can be turned on during a sustain period following the address period. More specifically, all the discharge cells are turned off during a reset period of a selective write subfield, and the discharge cells selected by generating an address discharge are turned on during an address period following the reset period. Sequentially, a sustain discharge occurs inside the selected discharge cells during a sustain period following the address period, thereby displaying an image.

The discharge cell to which a scan signal is supplied during an address period of a selective erase subfield can be turned off during a sustain period following the address period. More specifically, all the discharge cells are turned on during a reset period of a selective erase subfield, and the discharge cells selected by generating an address discharge are turned off during an address period following the reset period. Sequentially, a sustain discharge occurs inside the non-selected discharge cells during a sustain period following the address period, thereby displaying an image.

Because the discharge cells which will be turned on during the sustain period have to be selected during the address period of the selective write subfield, a sufficient amount of wall charges have to be accumulated during the address discharge. Accordingly, it may be advantageous that a width of the scan signal supplied during the address period of the selective write subfield is sufficiently wide.

On the other hand, because the discharge cells which will be turned off during the sustain period have to be selected during the address period of the selective erase subfield, a sufficient amount of wall charges have to be erased during the address discharge. Accordingly, it may be advantageous that a width of the scan signal supplied during the address period of the selective erase subfield is sufficiently narrow.

It may be advantageous that the width of the scan signal supplied during the address period of the selective erase subfield is smaller than width of the scan signal supplied during the address period of the selective write subfield.

Because the discharge cells to be turned off have to be selected in the selective erase subfield, a previous subfield of a given selective erase subfield has to be turned on so as to turn on the given selective erase subfield. Because the discharge cells to be turned off are selected from the discharge cells, which were turned on during the previous subfield, in the given selective erase subfield, a reset period for initialization may be omitted in the given selective erase subfield.

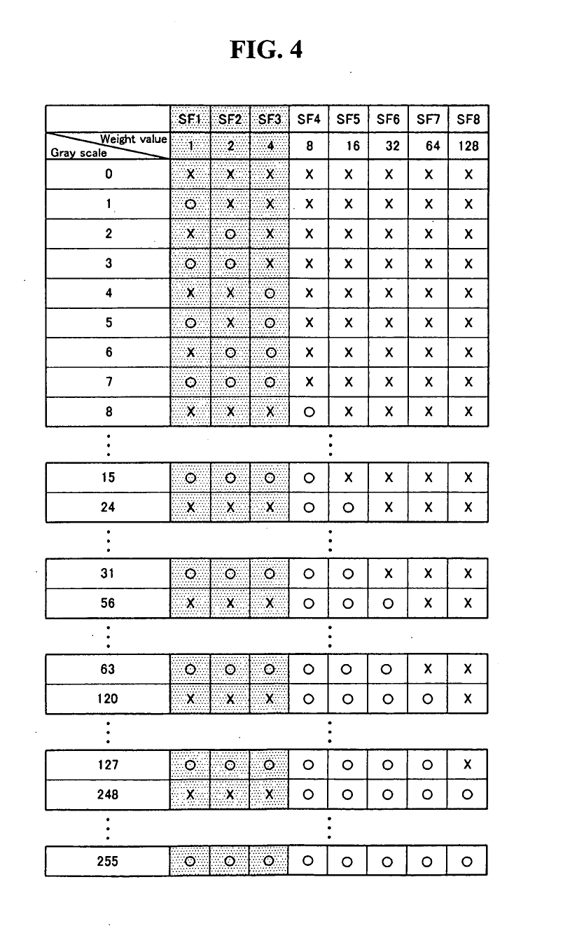

FIG. 4 is a diagram for explaining an example of a method for achieving a gray scale of an image.

FIG. 4 shows the case where a weight value of each subfield increases in a ratio of 2ⁿ (where n=0, 1, 2, 3, 4, 5, 6, 7) in such a method of setting a weight value of a first subfield SF1 at 2⁰ and a weight value of a second subfield SF2 at 2¹. In FIG. 4, the first to third subfields SF1 to SF3 may be a selective write subfield, and the fourth to eighth subfields SF4 to SF8 may be a selective erase subfield.

Although FIG. 4 has shown and described the case where a frame includes 8 subfields, the number of subfields constituting a frame may variously change. For example, a frame may include 10 subfields or 12 subfields.

1 gray level can be achieved by turning on the first subfield SF1 and turning off the other subfields SF2 to SF8. 2 gray levels can be achieved by turning on the second subfield SF2, 5 gray levels can be achieved by turning on the first and third subfields SF1 and SF3, and 8 gray levels can be achieved by turning on the eighth subfield SF8. 15 gray levels can be achieved by turning on the first to fourth subfields SF1 to SF4, and 24 gray levels can be achieved by turning on the fourth and fifth subfields SF4 and SF5. Therefore, 255 gray levels can be achieved by turning on all the subfields SF1 to SF8.

The first to third subfields SF1 to SF3 corresponding to the selective write subfield may use a binary coding manner in which one or more predetermined subfields are selected and weight values of the selected subfields are combined. The fourth to eighth subfields SF4 to SF8 corresponding to the selective erase subfield may use an increment coding manner in which subfields are selected in disposition order.

A reason why a frame includes at least one selective write subfield and at least one selective erase subfield will be described below.

As described above, the width of the scan signal in the selective erase subfield may be smaller than the width of the scan signal in the selective write subfield, and the reset period may be omitted in the selective erase subfield. Therefore, a length of the selective erase subfield may be shorter than a length of the selective write subfield. Accordingly, if a frame includes at least one selective write subfield and at least one selective erase subfield, the number of subfields constituting the frame can increase. Hence, a false contour noise can be improved.

On the other hand, if a frame includes only selective erase subfields, all the discharge cells have to be turned on in a subfield which is first arranged in tire order. Therefore, a black luminance may increase and a contrast characteristic may worsen. However, in a selective write subfield, only the discharge cells to be turned on are selected during an address period, and only the discharge cells selected during the address period are turned on during a sustain period. In other words, because only the selected discharge cells are turned on in a turned-off state of all the discharge cells in the selective write subfield, the contrast characteristic can be improved.

If a frame includes only selective write subfields, all the selective write subfields have to include a reset period for initializing all the discharge cells. Therefore, the number of subfields constituting the frame may decrease, and the generation of the false contour noise may increase.

If a frame includes a selective write subfield and a selective erase subfield, an image can displayed in a manner where the selective erase subfield follows the selective write subfield and the discharge cells selected in the selective write subfield are selectively turned off in the selective erase subfield.

In this case, because it is possible to selectively turn off the discharge cells, which were selectively turned on during the selective write subfield, during the selective erase subfield, the contrast characteristic can be more excellent than the case where a frame includes only the selective erase subfields. Further, because a reset period may be omitted in the selective erase subfield, the number of subfields constituting the frame can be-more than the case where the frame includes only the selective write subfields.

Accordingly, if the frame includes at least one selective write subfield and at least one selective erase subfield, the number of subfields constituting the frame can increase and the false contour noise can be improved. Further, the contrast characteristic and the image quality can be improved.

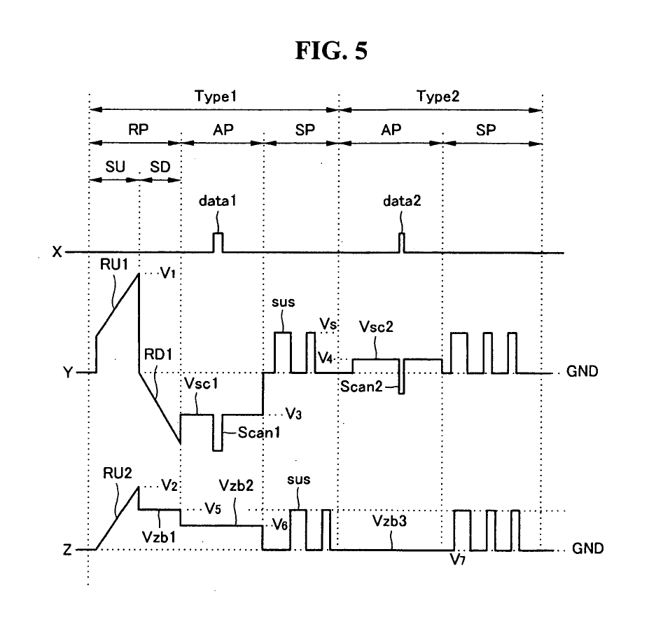

A driving waveform in a selective write subfield and a selective erase subfield will be described in detail with reference to FIGS. 5 to 7.

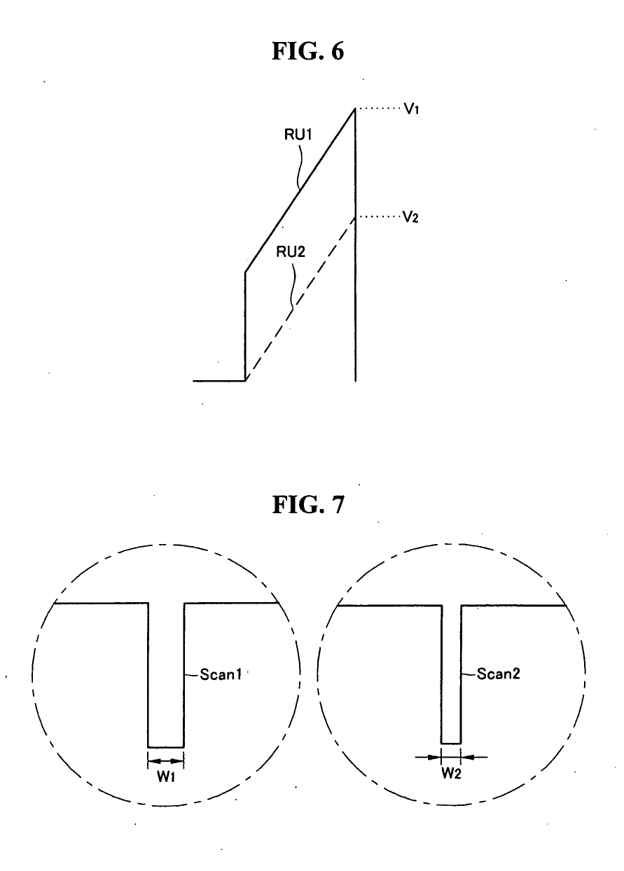

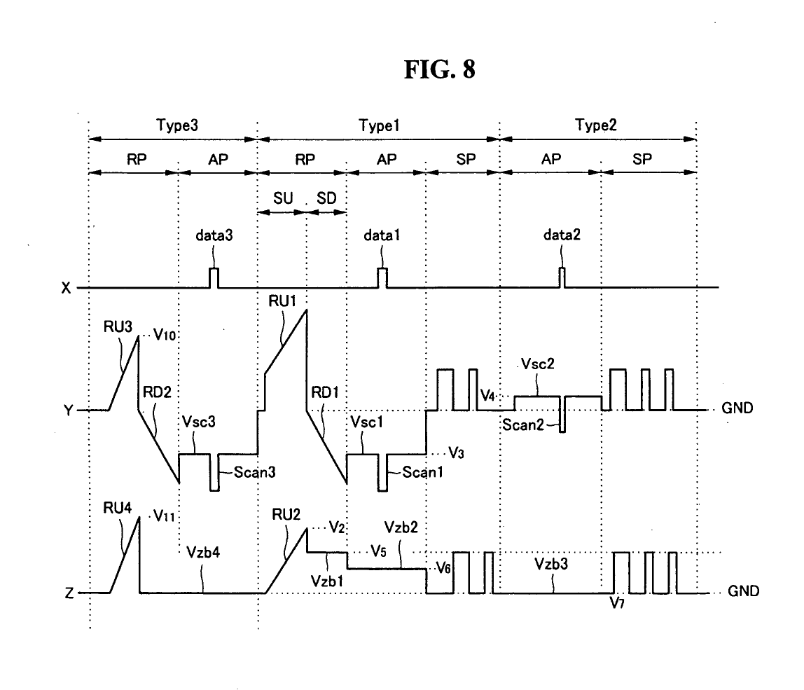

FIG. 5 is a diagram for explaining an example of a driving waveform during a selective write subfield and a selective erase subfield. FIG. 6 is a diagram comparing a first rising signal with a second rising signal, and FIG. 7 is a diagram comparing a first scan signal with a second scan signal. Driving signals shown in FIGS. 5 to 7 are supplied by the driver 110 shown in FIG. 1.

As shown in FIG. 5, a first rising signal RU1 with a gradually rising voltage and a first falling signal RD1 with a gradually falling voltage may be supplied to the scan electrode Y during a reset period RP of a type 1 subfield. The type 1 subfield may be a selective write subfield. A type 2 subfield following the type 1 subfield may be a selective erase subfield.

The first rising signal RU1 may be supplied to the scan electrode Y during a setup period SU, thereby generating a weak dark discharge (i.e., a setup discharge) inside the discharge cells. Hence, a proper amount of wall charges may be accumulated inside the discharge cells.

Then, the first falling signal RD1 may be supplied to the scan electrode Y during a set-down period SD, thereby generating a weak erase discharge (i.e., a set-down discharge) inside the discharge cells. Hence, the remaining wall charges are uniform inside the discharge cells to the extent that an address discharge occurs stably.

A second rising signal RU2 corresponding to the first rising signal RU1 may be supplied to the sustain electrode Z during the reset period RP. Hence, a sharp rise in a voltage difference between the scan electrode Y and the sustain electrode Z during the setup period SU can be prevented, and a strong discharge between the scan electrode Y and the sustain electrode Z can be prevented. Accordingly, the contrast characteristic can be improved.

As shown in FIG. 6, a highest voltage V1 of the first rising signal RU1 nay be greater than a highest voltage V2 of the second rising signal RU2. Hence, the setup discharge generated during the setup period SU can be stabilized.

A rate of voltage change over time in the first rising signal RU1 nay be substantially equal to or different from a rate of voltage change over time in the second rising signal RU2.

A first sustain bias signal Vzb1 corresponding to the first falling signal RD1 way be supplied to the sustain electrode Z during the reset period RP. Hence, the set-down discharge can occur stably, and a state of the wall charges distributed inside the discharge cells can be uniform.

A first scan bias signal Vsc1 having a third voltage V3 greater than a lowest voltage of the first falling signal RD1 may be supplied to the scan electrode Y during an address period AP following the reset period RP. A first scan signal Scan1 falling from the first scan bias signal Vsc1 nay be supplied to the scan electrode Y. When the first scan signal Scan1 is supplied to the scan electrode Y, a first data signal data1 corresponding to the first scan signal Scan1 may be supplied to the address electrode X. As a voltage difference between the first scan signal Scan1 and the first data signal data1 is added to the wall voltage produced during the reset period RP, an address discharge occurs inside the discharge cells to which the first data signal data1 is supplied.

During the address period, a second sustain bias signal Vzb2 my be supplied to the sustain electrode Z so as to prevent the address discharge from being unstable by an interference of the sustain electrode Z. A voltage V6 of the second sustain bias signal Vzb2 may be smaller than a voltage V5 of the first sustain bias signal Vzb1 so as to further stabilize the address discharge.

During a sustain period SP following the address period AP, a sustain signal sus may be supplied to at least one of the scan electrode Y or the sustain electrode Z. For instance, the sustain signal sus may be alternately supplied to the scan electrode Y and the sustain electrode Z. As the wall voltage inside the discharge cell selected by performing the address discharge is added to a sustain voltage Vs of the sustain signal SUS, every time the sustain signal sus is supplied, a sustain discharge, i.e., a display discharge occurs between the scan electrode Y and the sustain electrode Z.

A plurality of sustain signals are supplied during a sustain period of at least one subfield, and a width of at least one of the plurality of sustain signals may be different from widths of the other sustain signals. For instance, a width of a first supplied sustain signal among the plurality of sustain signals may be larger than widths of the other sustain signals. Hence, a sustain discharge can more stably occur.

A reset period for initialization may be omitted in the type 2 subfield following the type 1 subfield.

During an address period AP of the type 2 subfield, a second scan bias signal Vsc2 may be supplied to the scan electrode Y, and a second scan signal Scan2 falling from the second-scan bias signal Vsc2 may be supplied to the scan electrode Y. A second data signal data2 corresponding to the second scan signal Scan2 may be supplied to the address electrode X. An address discharge occurs due to a voltage difference between the second scan signal Scan2 and the second data signal data2, and thus wall charges inside the discharge cells can be erased.

Because a sufficient amount of wall charges have to be accumulated through the address discharge during the address period AP of the type 1 subfield corresponding to the selective write subfield, the width of the first scan signal Scan1 has to be sufficiently wide. On the other hand, because a sufficient amount of wall charges have to be erased through the address discharge during the address period AP of the type 2 subfield corresponding to the selective erase subfield, the width of the second scan signal Scan2 has to be sufficiently narrow.

Accordingly, as shown in FIG. 7, it may be advantageous that a width W1 of the first scan signal Scan1 is wider than a width W of the second scan signal Scan2.

During the address period AP of the type 2 subfield, a third sustain bias signal Vzb3 may be supplied to the sustain electrode Z so as to prevent the generation of a strong discharge between the scan electrode Y and the sustain electrode Z and to uniformly erase wall charges. A voltage V7 of the third sustain bias signal Vzb3 may be smaller than the voltage V6 of the second sustain bias signal Vzb2.

A voltage V4 of the second scan signal Scan2 may be greater than a voltage V3 of the first scan signal Scan1 so as to prevent a strong discharge from occurring between the scan electrode Y and the sustain electrode Z during the address period AP of the type 2 subfield.

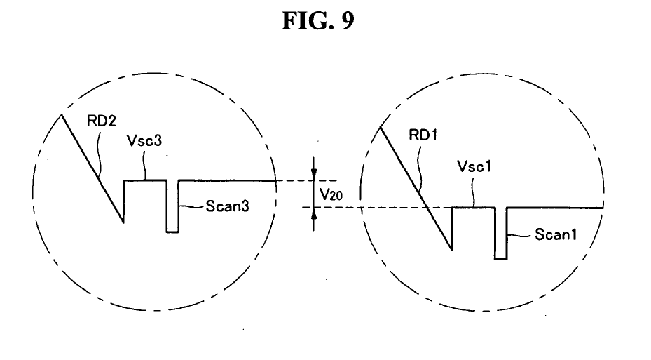

FIGS. 8 and 9 are diagrams for explaining a third type subfield. In FIGS. 8 and 9, type 1 and type 2 subfields described with reference to FIGS. 5 to 7 are used.

As shown in FIG. 8, at least one type 1 subfield may follow a type 3 subfield in which a sustain period is omitted. The type 1 and type 3 subfields may be a selective write subfield.

During a reset period of the type 3 subfield, a third rising signal RU3 with a gradually rising voltage may be supplied to the scan electrode Y, and a fourth rising signal RU4 corresponding to the third rising signal RU3 may be supplied to the sustain electrode Z.

A highest voltage V10 of the third rising signal RU3 may be substantially equal to a highest voltage V11 of the fourth rising signal RU4. Hence, a discharge can be prevented from occurring between the scan electrode Y and the sustain electrode Z during the reset period of the type 3 subfield, and a discharge between the scan electrode Y and the address electrode X can be induced. Accordingly, the contrast characteristic can be improved, and the generation of image sticking can be reduced.

After the supply of the third rising signal RU3, a second falling signal RD2 with a gradually falling voltage may be supplied to the scan electrode Y, thereby generating a set-down discharge during the reset period of the type 3 subfield. Hence, the wall charges can be uniformly distributed inside the discharge cells.

During an address period, a third scan bias signal Vsc3 and a third scan signal Scan3 may be supplied to the scan electrode Y, and a fourth sustain bias signal Vzb4 may be supplied to the sustain electrode Z.

A voltage of the fourth sustain bias signal Vzb4 may be substantially equal to the voltage V7 of the third sustain bias signal Vzb3, which is supplied to the sustain electrode Z during the address period of the type 2 subfield. The voltage V7 of the third sustain bias signal Vzb3 and the voltage of the fourth sustain bias signal Vzb4 may be substantially equal to a ground level voltage GND.

As shown in FIG. 9, a voltage of the third scan bias signal Vsc3 may be smaller than the ground level voltage GND and may be greater than the voltage of the first scan bias signal Vsc1 by a voltage magnitude V20. Hence, the quantity of light generated during the address period can be reduced, and the gray scale can be more finely represented.

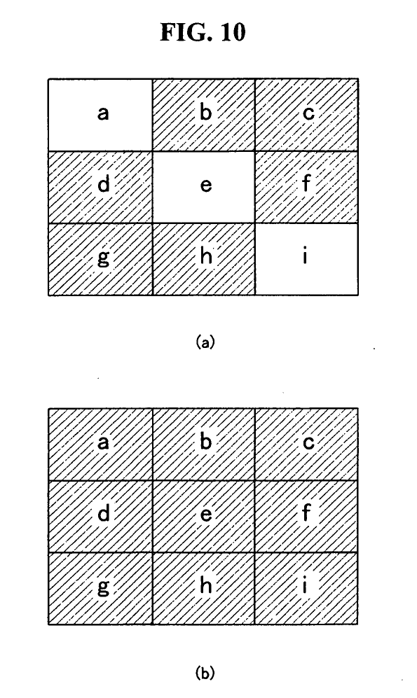

FIG. 10 is a diagram for explaining a reason why a sustain period is omitted in the third type subfield.

Supposing that sustain signals are supplied to the scan electrode and the sustain electrode during a sustain period, respectively, a gray scale can be achieved by adding the quantity of light generated during reset, address, and sustain periods.

It is assumed that a gray level of light generated by one sustain signal, namely, a gray level of light generated by a sustain discharge is 0.5, and a gray level of light generated by a data signal and a scan signal, namely, a gray level of light generated by an address discharge is 0.5. Light generated during a reset period is negligible. The assumptions are voluntarily set for the convenience of explanation.

As shown in (a) of FIG. 10, if an image with 0.5 gray level is displayed in an area comprised of 3×3 discharge cells a to i, the three discharge cells a, e, and i have to be turned on. Hence, a gray level of light generated in the area comprised of the 9 discharge cells a to i is 4.5 (=1.5×3). It may be perceived that a gray level of the image displayed in each of the 9 discharge cells is 0.5. However, in case of a manner illustrated in (a) of FIG. 10, a given pattern may be displayed on the screen. In other words, the image quality may worsen.

On the other hand, in case of the type 3 subfield of FIG. 8 in which the sustain period is omitted, a gray level representable in one subfield is a gray level (=0.5) of light generated by only an address discharge.

As shown in (b) of FIG. 10, if an image with 0.5 gray level is displayed in an area comprised of 3×3 discharge cells a to i, all the 9 discharge cells a to i have to be turned on. Hence, in case of a manner illustrated in (b) of FIG. 10, a given pattern may not be displayed on the screen. In other words, the image quality may be improved.

As described above, in case a frame includes a selective write subfield and a selective erase subfield, an address discharge for accumulating wall charges has to occur during an address period of the selective write subfield, and an address discharge for erasing wall charges has to occur during an address period of the selective erase subfield.

Because characteristics of the address discharge frequently change, the address discharge may be sharply unstable. For instance, even if the intensity of the address discharge is slightly larger, it is difficult to sufficiently erase the wall charges during the address period of the selective erase subfield. Even if the intensity of the address discharge is slightly smaller, it is difficult to sufficiently accumulate the wall charges during the address period of the selective write subfield.

Accordingly, in case a frame includes a selective write subfield and a selective erase subfield, it may be advantageous that an additive material such as MgO is added to the phosphor layer so as to stabilize an address discharge.

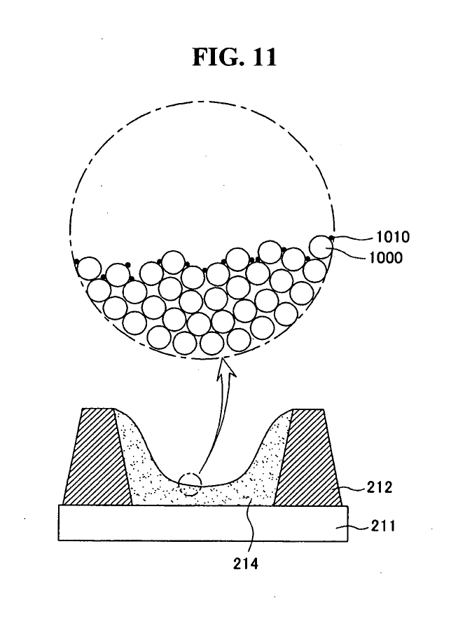

FIG. 11 shows a phosphor layer.

As shown in FIG. 11, the phosphor layer 214 includes particles 1000 of a phosphor material and particles 1010 of an additive material.

The particles 1010 of the additive material has a high secondary electron emission coefficient and can improve a discharge response characteristic between the scan electrode and the address electrode or between the sustain electrode and the address electrode. This will be below described in detail.

When a scan signal is supplied to the scan electrode and a data signal is supplied to the address electrode, charges may be accumulated on the surface of the particles 1000 of the phosphor material.

If the phosphor layer 214 does not include an additive material, charges may be concentratedly accumulated on a specific portion of the phosphor layer 214 because of the nonuniform height of the phosphor layer 214 and the nonuniform distribution of the particles of the phosphor material. Hence, a relatively strong discharge may occur in the specific portion of the phosphor layer 214 on which charges are concentratedly accumulated.

Further, charges may be concentratedly accumulated in a different area of each discharge cell, and thus a discharge may occur unstably and nonuniformly. In this case, the image quality of a displayed image may worsen, and thus a viewer may watch a noise such as spots.

On the other hand, in case the phosphor layer 214 includes the additive material such as MgO as in the exemplary embodiment, the particles of the additive material act as a catalyst of a discharge due to their high secondary electron emission coefficient. Hence, a discharge can stably occur between the scan electrode and the address electrode at a relatively low voltage. Accordingly, before the strong discharge occurs at a relatively high voltage in the specific portion of the phosphor layer 214, on which charges are concentratedly accumulated, a discharge can occur at a relatively low voltage in a portion of the phosphor layer 214, on which the particles of the additive material are positioned. Hence, discharge characteristics of each discharge cell can be uniform.

In case a frame includes a selective write subfield and a selective erase subfield, an address discharge for accumulating wall charges and an address discharge for erasing wall charges occur together. Therefore, it is a great likelihood of the generation of the unstable address discharge. However, in case the phosphor layer includes the additive material, a discharge generated between the scan electrode and the address electrode can be stabilized. Therefore, the address discharge can be prevented from unstably occurring.

The additive material is not limited particularly except the improvement of the discharge response characteristic between the scan electrode and the-address electrode or between the sustain electrode and the address electrode. Examples of the additive material include at least one of magnesium oxide (MgO), zinc oxide (ZnO), silicon oxide (SiO₂), titanium oxide (TiO₂), yttrium oxide (Y₂O₃), aluminum oxide (Al₂O₃), lanthanum oxide (La₂O₃), europium oxide (EuO), cobalt oxide, iron oxide, or CNT (carbon nano tube). It may be advantageous that the additive material is MgO.

At least one of the particles 1000 of the phosphor material on the surface of the phosphor layer 214 may be exposed toward the center of the discharge cell. For instance, since the particles 1010 of the additive material are disposed between the particles 1000 of the phosphor material on the surface of the phosphor layer 214, at least one particle 1000 of the phosphor material may be exposed.

As described above, when the particles 1010 of the additive material are disposed between the particles 1000 of the phosphor material, a discharge response characteristic between the scan electrode and the address electrode or between the sustain electrode and the address electrode can be improved. Further, since the surface area of the particles 1000 of the phosphor material covered by the particles 1010 of the additive material may be minimized, an excessive reduction in a luminance can be prevented.

Although it is not shown, if the particles 1010 of the additive material are uniformly coated on the surface of the phosphor layer 214, and a layer formed of the additive material is formed on the surface of the phosphor layer 214, the additive layer covers the most of the surface of the particles 1000 of the phosphor material. Hence, a luminance may be excessively reduced.

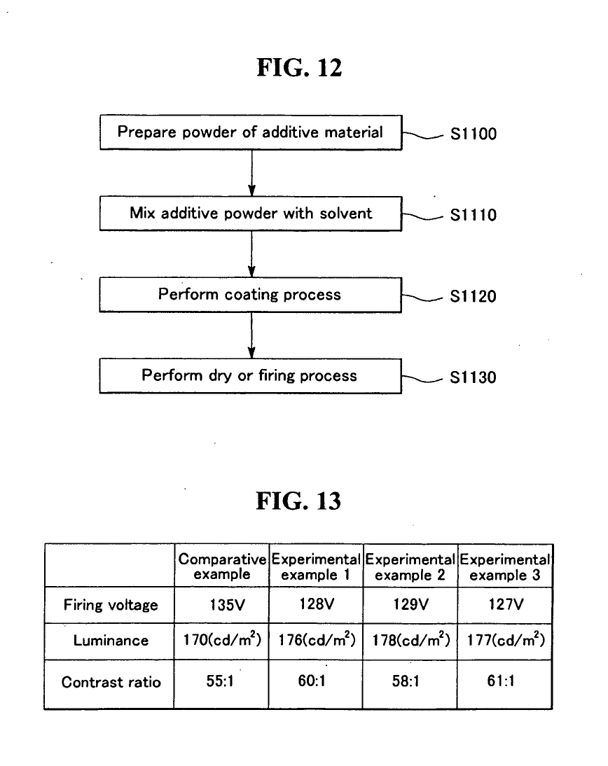

FIG. 12 is a diagram for explaining an example of a method of manufacturing a phosphor layer.

As shown in FIG. 12, first, a powder of an additive material is prepared in step S1100. For instance, a gas oxidation process is performed on Mg vapor generated by heating Mg to form a powder of MgO.

Next, the prepared additive power is mixed with a solvent in step S1110. For instance, the resulting MgO powder is mixed with methanol to manufacture an additive paste or an additive slurry. A binder may be added so as to adjust a viscosity of the additive paste or the additive slurry.

Subsequently, the additive paste or slurry is coated on the phosphor layer in step S1120. In this case, a viscosity of the additive paste or the additive slurry is adjusted so that the particles of the additive material are smoothly positioned between the particles of the phosphor material.

Subsequently, a dry process or a firing process is performed in step S1130. Hence, the solvent mixed with the additive material is evaporated to form the phosphor layer of FIG. 11.

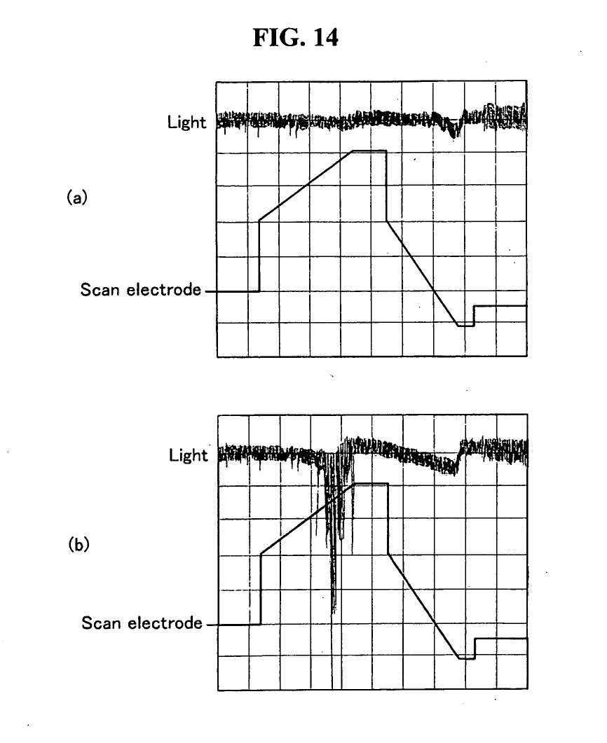

FIGS. 13 and 14 are diagrams for explaining an effect of an additive material.

FIG. 13 is a table showing a firing voltage, a luminance of a displayed image, and a bright room contrast ratio of each of a comparative example and experimental examples 1, 2 and 3. The bright room contrast ratio measures a contrast ratio in a state where an image with a window pattern occupying 45% of the screen size is displayed in a bright room. The firing voltage is a firing voltage measured between the scan electrode and the address electrode.

In the comparative example, the phosphor layer does not include an additive material.

In the experimental example 1, the phosphor layer includes MgO of 3% based on the volume of the phosphor layer as an additive material.

In the experimental example 2, the phosphor layer includes MgO of 9% based on the volume of the phosphor layer as an additive material.

In the experimental example 3, the phosphor layer includes MgO of 12% based on the volume of the phosphor layer as an additive material.

In the comparative example, the firing voltage is 135V, and the luminance is 170 cd/m2.

In the experimental examples 1, 2 and 3, the firing voltage is 127V to 129V lower than the firing voltage of the comparative example, and the luminance is 176 cd/m2 to 178 cd/m2 higher than the luminance of the comparative example. Because the particles of the MgO material as the additive material in the experimental examples 1, 2 and 3 act as a catalyst of a discharge, the firing voltage between the scan electrode and the address electrode is lowered. Furthermore, in the experimental examples 1, 2 and 3, because an intensity of a discharge generated at the same voltage as the comparative example increases due to a fall in the firing voltage, the luminance further increases.

While the bright room contrast ratio of the comparative example is 55:1, the bright room contrast ratio of the experimental examples 1, 2 and 3 is 58:1 to 61:1. As can be seen from FIG. 13, a contrast characteristic of the experimental examples 1, 2 and 3 is more excellent than that of the comparative example.

In the experimental examples 1, 2 and 3, a uniform discharge occurs at a lower firing voltage than that of the comparative example, and thus the quantity of light during a reset period is relatively small in the experimental examples 1, 2 and 3.

FIG. 14, (a) is a graph showing the quantity of light in the experimental examples 1, 2 and 3, and (b) is a graph showing the quantity of light in the comparative example.

As shown in (b) of FIG. 14, because an instantaneously strong discharge occurs at a relatively high voltage in the comparative example not including the MgO material, the quantity of light may instantaneously increase. Hence, the contrast characteristics may worsen.

As shown in (a) of FIG. 14, because a discharge occurs at a relatively low voltage in the experimental examples 1, 2 and 3 including the MgO material, a weak reset discharge continuously occurs during a reset period. Hence, a small quantity of light is generated, and the contrast characteristics can be improved.

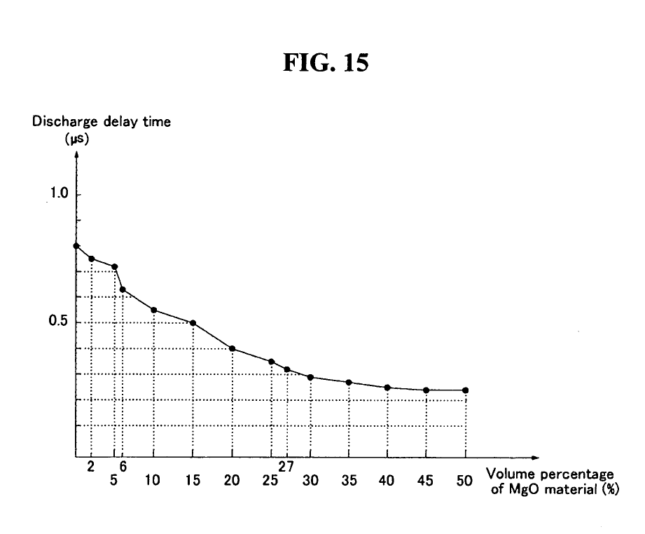

FIG. 15 is a graph measuring a discharge delay time of an address discharge while a percentage of a volume of MgO material used as an additive material based on the volume of the phosphor layer changes from 0% to 50%.

The address discharge delay time means a time interval between a time when the scan signal and the data signal are supplied during an address period and a time when an address discharge occurs between the scan electrode and the address electrode.

As shown in FIG. 15, when the volume percentage of the MgO material is 0 (in other words, when the phosphor layer does not include MgO material), the discharge delay time may be approximately 0.8 μs.

When the volume percentage of the MgO material is 2%, the discharge delay time is reduced to be approximately 0.75 μs. In other words, because the particles of the MgO material improve a discharge response characteristic between the scan electrode and the address electrode, an address jitter characteristic can be improved.

Further, when the volume percentage of the MgO material is 5%, the discharge delay time may be approximately 0.72 μs. When the volume percentage of the MgO material is 6%, the discharge delay time may be approximately 0.63 μs.

When the volume percentage of the MgO material lies in a range between 10% and 50%, the discharge delay time may be reduced from approximately 0.55 μs to 0.24 μs.

It can be seen from the graph of FIG. 15 that as a content of the MgO material increases, the discharge delay time can be reduced. Hence, the address jitter characteristic can be improved. However, an improvement width of the address jitter characteristic may gradually decrease. In case the volume percentage of the MgO material is equal to or more than 40%, a reduction width of the discharge delay time may be small.

On the other hand, in case the volume percentage of the MgO material is excessively large, the particles of the MgO material may excessively cover the surface of the particles of the phosphor material. Hence, a luminance may be reduced.

Accordingly, the percentage of the volume of the MgO material based on the volume of the phosphor layer may lie substantially in a range between 2% and 40% or between 6% and 27% so as to reduce the discharge delay time and to prevent an excessive reduction in the luminance.

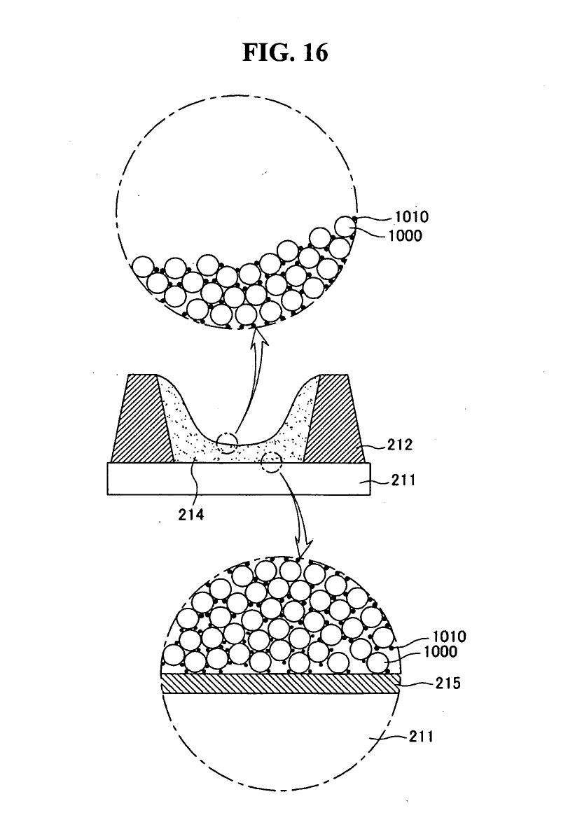

FIG. 16 shows another structure of a phosphor layer.

As shown in FIG. 16, the particles 1010 of the additive material may be positioned on the surface of the phosphor layer 214, inside the phosphor layer 214, and between the phosphor layer 214 and the lower dielectric layer 215.

When the particles 1010 of the additive material may be positioned on the surface of the phosphor layer 214, inside the phosphor layer 214, and between the phosphor layer 214 and the lower dielectric layer 215, a discharge response characteristic between the scan electrode and the address electrode or between the sustain electrode and the address electrode can be improved.

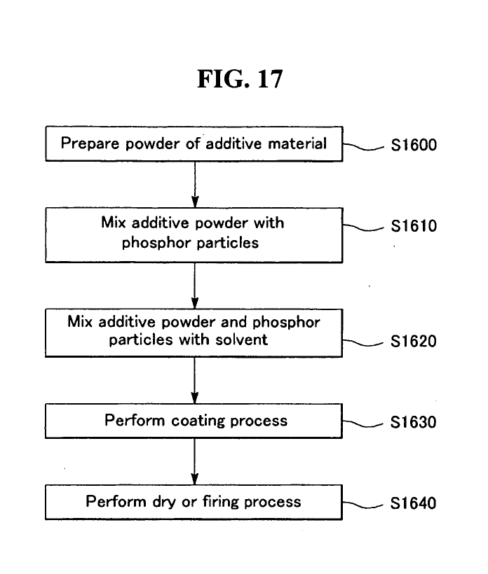

FIG. 17 illustrates an example of another method of manufacturing a phosphor layer.

As shown in FIG. 17, a powder of an additive material is prepared in step S1600.

The prepared additive power is mixed with phosphor particles in step S1610.

The additive power and the phosphor particles are mixed with a solvent in step S1620.

The additive power and the phosphor particles mixed with the solvent are coated inside the discharge cells in step S1630. In the coating process, a dispensing method may be used.

A dry process or a firing process is performed in step S1640 to evaporate the solvent. Hence, the phosphor layer having the structure shown in FIG. 16 is formed.

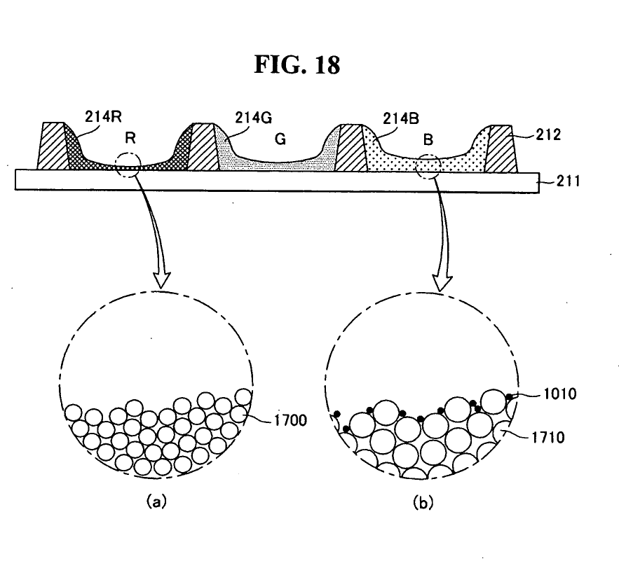

FIG. 18 is a diagram for explaining a method of selectively using an additive material.

As shown in FIG. 18, the phosphor layer includes a first phosphor layer 214R emitting red light, a second phosphor layer 214B emitting blue light, and a third phosphor layer 214G emitting green light. At least one of the first phosphor layer 214R, the second phosphor layer 214B, or the third phosphor layer 214G may not include the additive material.

For instance, as shown in (a), the first phosphor layer 214R includes particles 1700 of a first phosphor material, but does not include an additive material. As shown in (b), the second phosphor layer 214B includes particles 1710 of a second phosphor material and particles 1010 of an additive material. In this case, the quantity of light generated in the second phosphor layer 214B can increase, and thus a color temperature can be in-proved.

The size of the particles 1710 of the second phosphor material in (b) may be larger than the size of the particles 1700 of the first phosphor material in (a). In this case, a discharge in the second phosphor layer 214B in (b) may be more unstable than a discharge in the first phosphor layer 214R in (a). However, because the second phosphor layer 214B includes the particles 1010 of the additive material, the discharge in the second phosphor layer 214B can be stabilized.

The particles of the MgO material included in the phosphor layer may have one orientation or two or more different orientations. For instance, only (200)-oriented MgO material may be used, or (200)- and (111)-oriented MgO material may be used. However, (200)-oriented MgO material and (111)-oriented MgO material may be together used so as to improve a discharge response characteristic between the scan electrode and the address electrode or between the sustain electrode and the address electrode and to prevent the degradation of the phosphor layer.

For instance, while the (111)-oriented MgO material has a relatively higher secondary electron emission coefficient than the (200)-oriented MgO material, the (111)-oriented MgO material has a relatively weaker sputter resistance than the (200)-oriented MgO material. Further, wall charges accumulating characteristic of the (111)-oriented M material is weaker than that of the (200)-oriented MgO material.

Accordingly, in case only the (111)-oriented MgO material is used, it is possible to improve a discharge response characteristic between the scan electrode and the address electrode or between the sustain electrode and the address electrode. However, it is difficult to prevent the degradation of the phosphor layer.

On the other hand, in case only the (200)-oriented MgO material is used, it is possible to prevent the degradation of the phosphor layer. However, it is difficult to improve a discharge response characteristic between the scan electrode and the address electrode or between the sustain electrode and the address electrode.

Accordingly, the (200)-oriented MgO material and the (111)-oriented MgO material may be together used so as to improve the discharge response characteristic between the scan electrode and the address electrode or between the sustain electrode and the address electrode and to prevent the degradation of the phosphor layer.

In case the phosphor layer includes the MgO material, the amount of the (200)-oriented MgO material having the relatively stronger sputter resistance may be more than the amount of the (111)-oriented MgO material, considering a pressure of the discharge gas is adjusted so as to prevent the degradation of the phosphor particles.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A method of driving a plasma display panel displaying an image in a frame including a plurality of subfields,
wherein the plasma display panel includes:
a front substrate on which a scan electrode and a sustain electrode are positioned substantially parallel to each other;
a rear substrate positioned opposite the front substrate; and
a phosphor layer positioned between the front substrate and the rear substrate, the phosphor layer including a phosphor material and an additive material, the additive material including at least one of magnesium oxide (MgO), zinc oxide (ZnO), silicon oxide (SiO₂), titanium oxide (TiO₂), yttrium oxide (Y₂O₃), aluminum oxide (Al₂O₃), lanthanum oxide (La₂O₃), europium oxide (EuO), cobalt oxide, iron oxide, or CNT (carbon nano tube),
wherein at least one of the plurality of subfields is a selective write subfield, and at least one of the other subfields is a selective erase subfield.

2. The method of claim 1, wherein the frame includes a first part and a second part each including at least one subfield, and the second part follows the first part,
wherein the first part includes at least one selective write subfield, and the second part includes at least one selective erase subfield.

3. The method of claim 1, wherein a discharge cell, to which a scan signal is supplied during an address period of the selective write subfield, is turned on during a sustain period following the address period, and
a discharge cell, to which a scan signal is supplied during an address period of the selective erase subfield, is turned off during a sustain period following the address period.

4. The method of claim 3, wherein a width of the scan signal supplied in the selective erase subfield is smaller than a width of the scan signal supplied in the selective write subfield.

5. The method of claim 1, wherein the selective write subfield includes a reset period for initialization, and a reset period for initialization is omitted in the selective erase subfield.

6. The method of claim 1, wherein the additive material includes MgO material,
wherein the MgO material includes (200)-oriented MgO material and (111)-oriented MgO material, and the amount of the (111)-oriented MgO material is less than the amount of (200)-oriented MgO material.

7. The method of claim 1, wherein the plasma display panel further includes a lower dielectric layer between the phosphor layer and the rear substrate,
wherein at least one of particles of the additive material is positioned on the surface of the phosphor layer and between the phosphor layer and the lower dielectric layer.

8. The method of claim 1, wherein a percentage of a volume of the additive material based on a volume of the phosphor layer lies substantially in a range between 2% and 40%.

9. A method of driving a plasma display panel displaying an image in a frame including a plurality of subfields,
wherein a plasma display panel includes:
a front substrate on which a scan electrode and a sustain electrode are positioned substantially parallel to each other;
a rear substrate positioned opposite the front substrate; and
a phosphor layer positioned between the front substrate and the rear substrate, the phosphor layer including a phosphor material and MgO material,
wherein a first rising signal with a gradually rising voltage and a first falling signal with a gradually falling voltage are supplied to the scan electrode, and a second rising signal with a gradually rising voltage corresponding to the first rising signal is supplied to the sustain electrode during a reset period of at least one type 1 subfield of the plurality of subfields,
wherein a reset period is omitted in at least one type 2 subfield of the plurality of subfields.

10. The method of claim 9, wherein the type 2 subfield follows the type 1 subfield, the type 1 subfield is a selective write subfield, and the type 2 subfield is a selective erase subfield.

11. The method of claim 9, wherein a highest voltage of the first rising signal is greater than a highest voltage of the second rising signal.

12. The method of claim 9, wherein a first sustain bias signal corresponding to the first falling signal is supplied to the sustain electrode during the reset period of the type 1 subfield,
a second sustain bias signal is supplied to the sustain electrode during an address period following the reset period of the type 1 subfield, and
a voltage of the first sustain bias signal is greater than a voltage of the second sustain bias signal.

13. The method of claim 9, wherein a second sustain bias signal is supplied to the sustain electrode during an address period following the reset period of the type 1 subfield,
a third sustain bias signal is supplied to the sustain electrode during an address period of the type 2 subfield, and
a voltage of the second sustain bias signal is greater than a voltage of the third sustain bias signal.

14. The method of claim 9, wherein a first scan bias signal is supplied to the scan electrode during an address period following the reset period of the type 1 subfield,
a second scan bias signal is supplied to the scan electrode during an address period of the type 2 subfield, and
a voltage of the first scan bias signal is smaller than a voltage of the second scan bias signal.

15. The method of claim 9, wherein a scan signal is supplied to the scan electrode during address periods of the type 1 and type 2 subfields, and
a width of the scan signal supplied in the type 1 subfield is wider than a width of the scan signal supplied in the type 2 subfield.

16. The method of claim 9, wherein the at least one type 1 subfield follows a type 3 subfield, and a sustain period is omitted in the type 3 subfield.

17. The method of claim 16, wherein a third rising signal with a gradually rising voltage is supplied to the scan electrode, and a fourth rising signal corresponding to the third rising signal is supplied to the sustain electrode during a reset period of the type 3 subfield.

18. The method of claim 17, wherein a highest voltage of the third rising signal is substantially equal to a highest voltage of the fourth rising signal.

19. The method of claim 17, wherein after the supply of the third rising signal, a second falling signal with a gradually falling voltage is supplied to the scan electrode during the reset period of the type 3 subfield.

20. A plasma display apparatus comprising:
a plasma display panel including:
a front substrate on which a scan electrode and a sustain electrode are positioned substantially parallel to each other;
a rear substrate positioned opposite the front substrate; and
a phosphor layer positioned between the front substrate and the rear substrate, the phosphor layer including a phosphor material and MgO material; and
a driver that displays an image on the plasma display panel in a frame including a plurality of subfields,
wherein at least one of the plurality of subfields is a selective write subfield, and at least one of the other subfields is a selective erase subfield.
